(19) United States
(12) Patent Application Publication
(10) Pub. No.: US 2005/0258667 A1
(43) Pub. Date: Nov. 24, 2005

(54) Sheet steel connection joints of sections consisting of sheet steel

(76) Inventors: Axel Grueneklee, Duisburg (DE); Timo Faath, Pfullingen (DE)

Correspondence Address: PROSKAUER ROSE LLP;PATENT DEPARTMENT, 1585 BROADWAY, NEW YORK, NY, 10036-8299, US

(21) Appl. No.: 10/497,347

(22) PCT Filed: Oct. 18, 2002
(86) PCT No.: PCT/EP02/11679

§ 371 Date: Jul. 1, 2005

(30) Foreign Application Priority Data
Nov. 30, 2001 (DE) 101 58 995.6

(51) Int. Cl. B60N 2/00

(52) U.S. Cl. 296/204

(57) ABSTRACT

In order to achieve a rigid connecting node of profiles (1, 2) comprising steel plate, especially a frame structure of a vehicle body from the point of view of lightweight construction, one profile (2) consisting of two parallel belts (2a, 2b) and at least one connecting cross-piece (2c, 2d) grips with its two ends (2a*, 2b*), which project compared with the connecting cross-piece (2c, 2d), the other profile (1) having two parallel wall sections (1a, 1b), wherein the belt ends (2a*, 2b*) which abut flat against the wall sections (1a, 1b) are fixedly connected to the wall sections (1a, 1b), for example, by means of a welded joint (4a, 4b, 4c). Such a connecting node offers multiple compensation for tolerances and imparts the frame structure a high stiffness.

The invention relates to a connecting node of at least two profiles comprising steel plate, especially a frame structure of a vehicle body.

Critical points of a frame structure for vehicle bodies both with regard to manufacture, and also with regard to stiffness and also with regard to durability are the so-called connecting nodes. These are points at which at least two profiles are interconnected. Welded joints such as are possible on closed profiles in lorry and bus construction, cannot easily be implemented on profiles of a frame structure for private motor vehicles, which is dimensioned of steel plate using the lightweight construction principle, because of the thin wall thickness of the plate used for the profiles. For this reason, prefabricated nodal elements, which for example are manufactured by internal high-pressure forming of a preformed shaped component made of steel plate (DE 196 53 509 A1), are frequently used at the nodes. These nodal elements have connecting pieces onto which or into which the profiles of the frame structure, generally hollow profiles, can be placed. The hollow profiles placed thereon or therein can be additionally welded to the nodal element. The manufacturing expenditure for such a frame structure is high. The weight of a frame structure manufactured using such nodal elements is also higher compared with a frame structure using directly connected profiles. Finally, these offer scarcely any possibility for compensating for tolerances.

The object of the invention is to develop a connecting node of a frame structure of a vehicle body which consists of profiles from the point of view of lightweight construction, which makes it possible to achieve easy assembly of the profiles with simple compensation of tolerances at the connecting nodes and which exhibits a high-stiffness.

This object is solved using a connecting node of the type specified initially by the fact that one profile consists of two parallel belts and at least one connecting cross-piece and is placed with its opposite belt ends projecting beyond the connecting cross-piece or cross-pieces on the other profile having two parallel belts or wall sections, wherein the belt ends of one profile abut against the parallel belts or wall sections of the other profile and are thereby fixedly connected.

With the connecting node according to the invention, two profiles especially of a frame structure of a vehicle body can easily be directly interconnected using different joining technologies in a simple and quick fashion. The aspect of lightweight construction has thus been taken into account. During manufacture it is possible to achieve multiple compensation for tolerances and specifically both in the axial direction of the profile with the belts and the connecting cross-piece, by placing it less far onto the other profile, in the axial direction of the other profile, by displacing it in parallel on the other profile in its axial direction, and finally with respect to the angle between the two profiles because no fixed solid angle is predefined unlike in the case of the known nodal element with the connecting pieces. The design expenditure is very low because conventional profiles are used as the starting point only the profile with the belts and the cross-piece must be adapted if necessary so that the belt ends-project compared with the cross-piece. However, there are special profiles (e.g. “Davex” profiles, trademark of ThyssenKrupp Stahl AG) during whose production the projecting length can be produced. A rigid connection can also be implemented because as a result of the large overlap of the belt ends with the other profile, the widest possible range of joining technologies alone or combined can be implemented over large areas and/or with long joining seams.

It is also advantageous to use the afore-mentioned Davex profile for another reason. Since the cross-piece is clamped in grooves of the belts in a Davex profile, from the point of view of optimising the loading during its manufacture different materials and/or different material thicknesses can be used for the cross-piece and the belts. In addition, in the case of a Davex profile, the edge regions which project beyond the cross-pieces at the longitudinal edges for reasons of manufacturing technology can be used as a support for shear panels or other functional elements, which is not possible with other hollow profiles such as tubes.

In the case of a welded joint, the weld seam can be provided at various points. A first possibility involves the front edges of the projecting belt ends. However, for reasons of the highest possible stiffness it is better to arrange the weld seam at the lateral edges of the projecting belt ends. It is to be understood that the front edges can additionally be welded on. However, it is also possible to weld the connecting cross-piece or cross-pieces of one profile to the wall section of the other profile adjacent thereto. However, this is only possibly if the cross-piece abuts against this wall section.

The connecting node according to the invention is explained in detail hereinafter with reference to the drawings which show various exemplary embodiments. In detail in the figures:

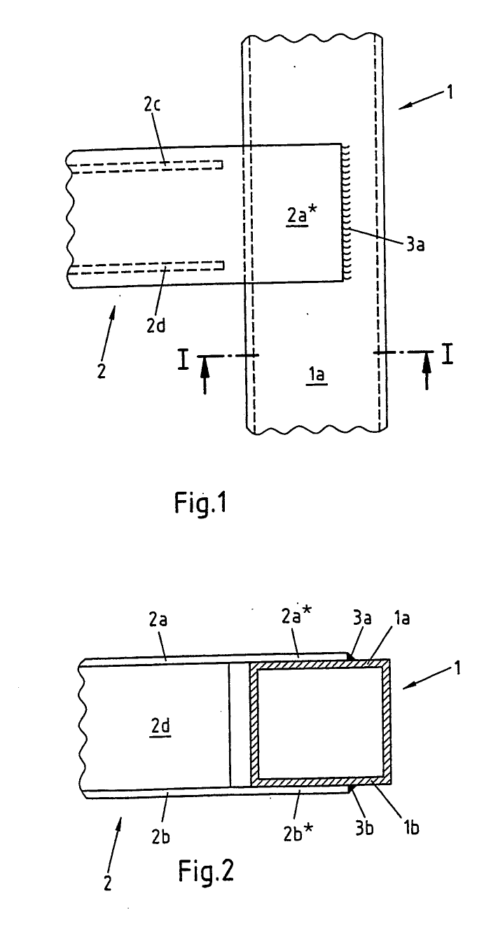

FIG. 1 shows a view of a connecting node of two profiles of a frame structure of a vehicle body as a section of the frame structure,

FIG. 2 shows the section along the line I-I in FIG. 1 of the connecting node from FIG. 1,

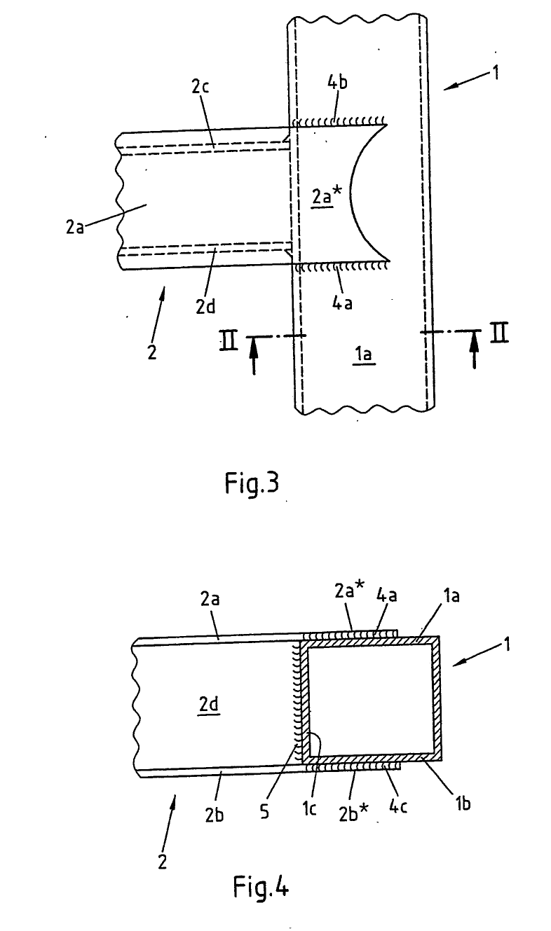

FIG. 3 shows a view of the connecting node of two profiles of a frame structure of a vehicle body in a modified design compared with FIGS. 1 and 2 as a section of the frame structure and

FIG. 4 shows the section along the line II-II in FIG. 3 of the connecting node from FIG. 3.

In the exemplary embodiment in FIG. 1 a connecting node is implemented on a profile 1 constructed as a hollow profile having a rectangular cross-section and a profile 2 formed from two belts 2a, 2b and two cross-pieces 2c, 3d connected thereto. The belts 2a, 2b project beyond the cross-pieces 2c, 2d with their belt ends 2a*, 2b*.

The profile 2 is a so-called “Davex” profile (trademark of ThyssenKrupp Stahl AG). A characteristic of the Davex profile is that the belts 2a, 2b and the cross-pieces 2c, 2d are joined by a pure crimped connection and specifically the cross-pieces 2c, 2d are inserted in grooves of the belts 2a, 2b and then crimped tightly. The use of Davex profiles has the advantage that different materials and different material thicknesses can be selected for the belts 2a, 2b and the cross-pieces 2c, 2d with the aim of optimising the loading and weight. In addition, there is also the advantage that during manufacture the cross-pieces 2c, 2d should be selected as shorter than the belts 2a, 2b so that the desired projecting length is obtained for the belt ends 2a*, 2b*.

In both exemplary embodiments the profile 2 is connected to the profile 1 via its two belt ends 2a*, 2b* which abut against and are welded to the parallel side wall sections 1a, 1b of the profile 1. Whereas in the exemplary embodiment in FIGS. 1 and 2 a welded seam 3a, 3b is applied to the front edge of the belt-ends 2a*, 2b*, in the exemplary embodiment in FIGS. 3 and 4 the welded seams 4a, 4b, 4c lie on the side edges of the belt ends 2a*, 2b*. This position of the welded seams 4a, 4b, 4c is preferred because it gives the nodal connection a higher stiffness. If the welded seams are located at this point, it is possible to recess the belt ends 2a*, 2b* at their front edges in an arc shape. The weight of the nodal connection is thereby reduced. Another difference between the exemplary embodiment in FIGS. 3 and 4 compared with that in FIGS. 1 and 2 is that the cross-pieces 2c, 2d reach as far as the profile 1 and are welded to said profile via a weld seam 5.

It is to be understood that as an alternative to the welded joints, soldered joints or glued joints can also be provided which can be implemented over a large area because of the large overlap so that a high stiffness of the nodal connection can thereby be achieved. In particular however, glued joints make it possible to use various materials for the profiles which cannot be welded or can only be welded one to the other with difficulty, such as aluminium and steel for example.

The nodal connection according to the invention allows multiple compensation for tolerances. On the one hand, it is possible to compensate for tolerance in the axial direction of the profile 2 by placing this more or less far onto the profile 1. The two exemplary embodiments show this possibility. In addition, the profile 2 can be displaced in parallel in the axial direction of the profile 1. Finally, different angles can also be set between the profiles 1, 2.

In any case, by means of a one-dimensional joining line between the belt ends 2a*, 2b* of the one profile 2 and the wall sections 1a, 1b of the other profile 1 without using additional auxiliary elements, a rigid, direct connection of the profiles which is simple and cheap to produce can be achieved, which also takes into account the aspect of light vehicle construction.

1-7. (canceled)

8. A connecting node of at least two profiles comprising steel plate, especially a frame structure of a vehicle body, wherein one profile consists of two parallel belts and at least one connection cross-piece and is placed with its opposite belt ends projecting beyond the connecting cross-piece or cross-pieces in the axial longitudinal direction of the profile on the other profile having two parallel belts or wall sections, wherein the belt ends of one profile abut against the parallel belts or wall sections of the other profile and are thereby fixedly connected, characterised in that in the case of the profile, the connecting cross-piece is fixedly clamped with its longitudinal edges on the belts by bilateral crimping of the belt material.

9. The connecting node according to claim 8, characterized in that the fixed connection between the profiles is a self-substance connection.

10. The connecting node according to claim 9, characterised in that the self-substance connection is a large-area adhesive or soldered joint between the superposed surfaces of the profiles.

11. The connecting node according to claim 9, characterised in that the self-substance connection is a welded joint whose seam lies on the front and/or lateral edges of the belt ends.

12. The connecting node according to claim 11, characterised in that the connecting cross-piece of one profile is welded to the wall section adjacent thereto of the other profile.

13. The connecting node according to claim 10, characterised in that in the case of a welded seam located only at the lateral edges of the belt ends, the belt ends are recessed in an arc shape at the front edges.
